(19) United States
(12) Patent Application Publication
(10) Pub. No.: US 2026/0309907 A1
(43) Pub. Date: Oct. 8, 2026

(54) MASKLESS COATING AS A PATTERNING MASK FOR EXTERNAL STIMULI IN DEPOSITIONS

(71) Applicant: Applied Materials, Inc., Santa Clara, CA (US)

(72) Inventors: Yingdong LUO, Newark, CA (US); Jinyu LU, Santa Clara, CA (US); Takashi KURATOMI, San Jose, CA (US); Xiaopei DENG, San Jose, CA (US); Rami HOURANI, Santa Clara, CA (US); Ludovic GODET, Sunnyvale, CA (US)

(21) Appl. No.: 19/478,978

(22) PCT Filed: May 10, 2024
(86) PCT No.: PCT/US2024/028709

§ 371 Date: Oct. 27, 2025

Related U.S. Application Data
(60) Provisional application No. 63/465,801, filed on May 11, 2023.

(51) Int. Cl. F21V 8/00; G02B 27/01

(52) U.S. Cl. CPC G02B 6/0065; G02B 6/0036; G02B 27/0172

(57) ABSTRACT

A method includes depositing a first precursor over a waveguide, the first precursor deposited over a first grating, a second grating, and an intermediate region between the first grating and the second grating of the waveguide and is deposited to have a first thickness. The method further includes performing a first ozone cure process, the first ozone cure process curing the first precursor, and depositing a second precursor over the waveguide. The second precursor is deposited over the first grating, the second grating, and the intermediate region and is deposited to have a second thickness. The method further includes depositing a coating over the intermediate region and the second grating, performing a second ozone cure process, the second ozone cure process curing the second precursor over the first grating, and removing the coating and the second precursor over the second grating and the intermediate region.

### BACKGROUND

### Field

Embodiments of the present disclosure generally relate to waveguides for augmented, virtual, and mixed reality. More specifically, embodiments described herein provide for forming waveguides.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality and forming waveguides. Therefore, there is a need for an improved method of forming waveguides.

### SUMMARY

In one embodiment, a method includes depositing a first precursor over a waveguide, the first precursor deposited over a first grating, a second grating, and an intermediate region between the first grating and the second grating of the waveguide. The first precursor is deposited to have a first thickness. The method further includes performing a first ozone cure process, the first ozone cure process curing the first precursor and depositing a second precursor over the waveguide. The second precursor is deposited over the first grating, the second grating, and the intermediate region. The second precursor is deposited to have a second thickness. The method further includes depositing a coating over the intermediate region and the second grating, performing a second ozone cure process, the second ozone cure process curing the second precursor over the first grating, and removing the coating and the second precursor over the second grating and the intermediate region.

In another embodiment, a method includes depositing a first precursor over a waveguide. The first precursor is deposited over a first grating, a second grating, and an intermediate region between the first grating and the second grating of the waveguide. The first precursor is deposited to have a first thickness. An upper surface of the first grating, the second grating, and the intermediate region have a hardmask material disposed thereon. The method further includes performing a first ozone cure process, the first ozone cure process curing the first precursor, removing the first precursor over the upper surface, removing the hardmask, and depositing a second precursor over the waveguide. The second precursor is deposited over the first grating, the second grating, and the intermediate region. The second precursor is deposited to have a second thickness. The method further includes depositing a coating over the intermediate region and the second grating, performing a second ozone cure process, the second ozone cure process curing the second precursor over the first grating, and removing the coating and the second precursor over the second grating and the intermediate region

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the present disclosure and are therefore not to be considered limiting of its scope, and may admit to other equally effective embodiments.

FIG. 1A is a perspective, frontal view of a waveguide according to one or more embodiments.

FIG. 1B is a schematic, cross-sectional view of a portion of a waveguide according to one or more embodiments.

FIG. 2 is a flow diagram of a method of forming a waveguide according to one or more embodiments.

FIGS. 3A-3F are schematic, cross-sectional views of a portion of a waveguide according to one or more embodiments.

FIG. 4 is a flow diagram of a method of forming a waveguide according to one or more embodiments.

FIGS. 5A-5H are schematic, cross-sectional views of a portion of a waveguide according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

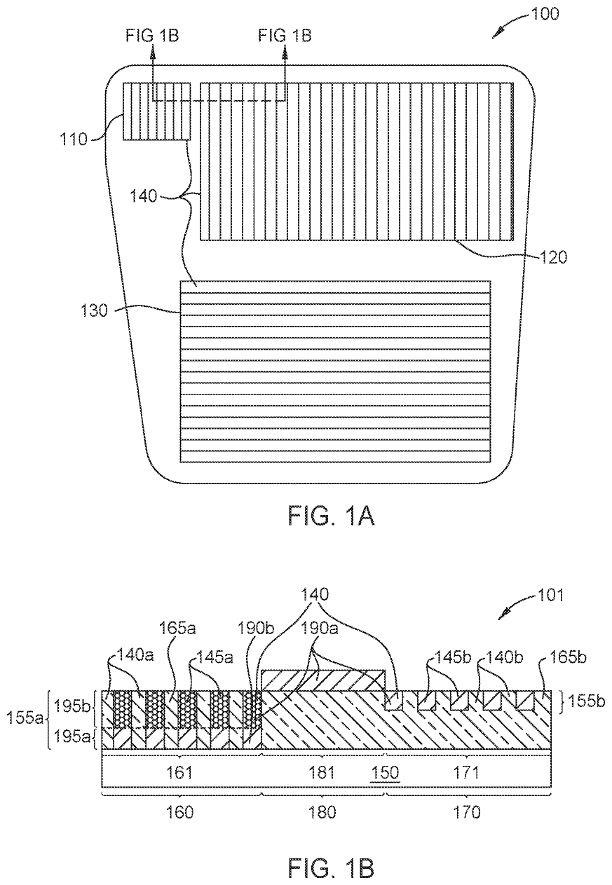

Embodiments of the present disclosure generally relate to waveguides for augmented, virtual, and mixed reality. More specifically, embodiments described herein provide for forming waveguides. FIG. 1A is a perspective, frontal view of a waveguide 100, according to one or more embodiments. In one embodiment, which can be combined with other embodiments described herein, the waveguide 100 is a waveguide combiner, such as an augmented reality waveguide combiner. The waveguide 100 includes an in-coupler grating 110, a pupil-expander grating 120, an out-coupler grating 130, and a waveguide substrate 150. Each grating of the waveguide 100 includes a plurality of grating structures 140.

FIG. 1B is a schematic, cross-sectional view of a portion 101 of a waveguide, such as the waveguide 100 of FIG. 1a, according to one or more embodiments. In one embodiment, which can be combined with other embodiments described herein, the waveguide 100 includes a plurality of grating structures 140 disposed over the waveguide substrate 150. Adjacent grating structures 140 form a plurality of trenches 145 therebetween. A first section 160 of the portion 101 of the waveguide 100 includes a first grating 161. The first grating 161 may be one of the in-coupler grating 110, the pupil-expander grating 120, or the out-coupler grating 130. The first grating 161 includes a plurality of first grating structures 140a. A plurality of first trenches 145a are formed between first grating structures 140a. A second section 170 of the portion 101 of the waveguide substrate 150 includes a second grating 171. The second grating 171 may be one of the in-coupler grating 110, the pupil-expander grating 120, the out-coupler grating 130. The second grating 171 includes a plurality of second grating structures 140b. A plurality of second trenches 145b are formed between second grating structures 140b. In one embodiment, which can be combined with other embodiments described herein, a third section 180 includes an intermediate region 181 between the first grating 161 and the second grating 171.

The first grating structures 140a have a first depth 155a and the second grating structures 140b have a second depth 155b. In one embodiment, which can be combined with other embodiments described herein, the first depth 155a is greater than the second depth 155b. In one embodiment, which can be combined with other embodiments described herein, a first cured precursor 190a is formed in the first trenches 145a, the second trenches 145b, and over the intermediate region 181. The first cured precursor 190a has a first thickness 195a. A second cured precursor 190b is formed in the first trenches 145a over the first cured precursor 190a. The second cured precursor has a second thickness 195b. The second depth 155b is equal to the first thickness 195a. The first depth 155a is equal to the first thickness 195a and the second thickness 195b. In one embodiment, which can be combined with other embodiments described herein, the first cured precursor 190a over the intermediate region 181 is not present.

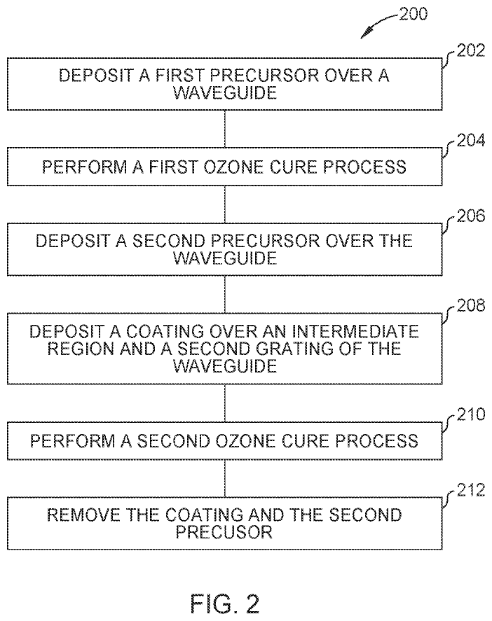

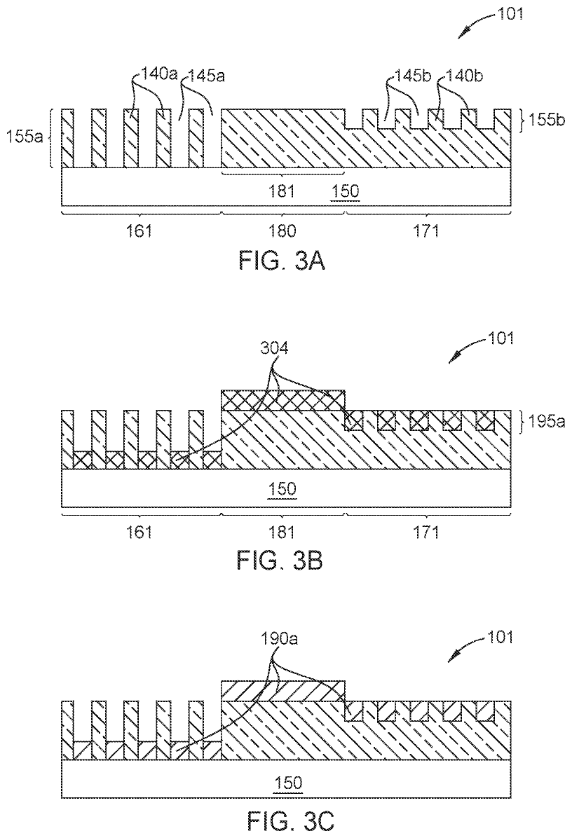

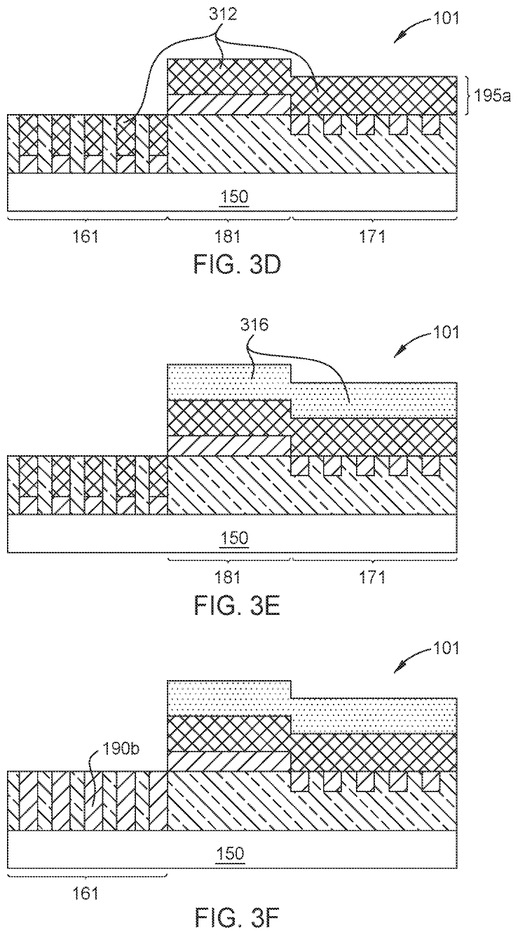

FIG. 2 is a flow diagram of a method 200 of forming a waveguide 100 according to one or more embodiments. FIGS. 3A-3F are schematic, cross-sectional views of a portion 101 of a waveguide 100 according to one or more embodiments.

FIG. 3A includes a plurality of first grating structures 140a disposed over a first grating 161 of the portion 101 of a waveguide substrate 150. Adjacent first grating structures 140a form a plurality of first trenches 145a therebetween. FIG. 3A further includes a plurality of second grating structures 140b disposed over a second grating 171 of the portion 101 of the waveguide substrate 150. Adjacent second grating structures 140b form a plurality of second trenches 145b therebetween. A third section 180 of the portion 101 of the waveguide 100 includes an intermediate region 181 which does not include grating structures 140 thereon or thereover. In one embodiment, which can be combined with other embodiments described herein, the first grating 161 and the second grating 171 may correspond to any of the in-coupler grating 110, the pupil-expander grating 120, or the out-coupler grating 130, as shown in FIG. 1A.

The plurality of first grating structures 140a have a first depth 155a. The plurality of second grating structures 140b have a second depth 155b. In one embodiment, which can be combined with other embodiments described herein, the first depth 155a is greater than the second depth 155b.

At operation 202, as shown in FIG. 3B, a first precursor 304 is deposited over the waveguide 100. The first precursor 304 is deposited over the first grating 161, the second grating 171, and the intermediate region 181. The first precursor 304 has first thickness 195a. In one embodiment, which can be combined with other embodiments described herein, the first precursor is a trisilylamine (TSA). The first precursor 304 may be deposited via flowable chemical vapor deposition (FCVD) or chemical vapor deposition (CVD).

At operation 204, as shown in FIG. 3C, a first ozone cure process is performed. In one embodiment, which can be combined with other embodiments described herein, the first ozone cure process is an ozone (O₃) soak. The first ozone cure process cures the first precursor 304, leaving a first cured precursor 190a.

At operation 206, as shown in FIG. 3D, a second precursor 312 is deposited over the waveguide 100. The second precursor 312 is deposited over the first grating 161, the second grating 171, and the intermediate region 181. The second precursor 312 has a second thickness 195b. In one embodiment, which can be combined with other embodiments described herein, the first thickness 195a and the second thickness 159b are different. In one embodiment, which can be combined with other embodiments described herein, the first precursor 304 and the second precursor 312 may be the same material.

At operation 208, as shown in FIG. 3E, a coating 316 is deposited over the intermediate region 181 and the second grating 171. The coating 316 may be a water soluble coating. In one embodiment, which can be combined with other embodiments described herein, the coating 316 is deposited via inkjet deposition.

At operation 210, as shown in FIG. 3F, a second ozone cure process is performed. The second ozone cure process cures the second precursor 312 over the first grating 161, leaving a second cured precursor 190b.

At operation 212, as shown in FIG. 1B, the coating 316 and the second precursor 312 located over the second grating 171 and the intermediate region 181 are removed.

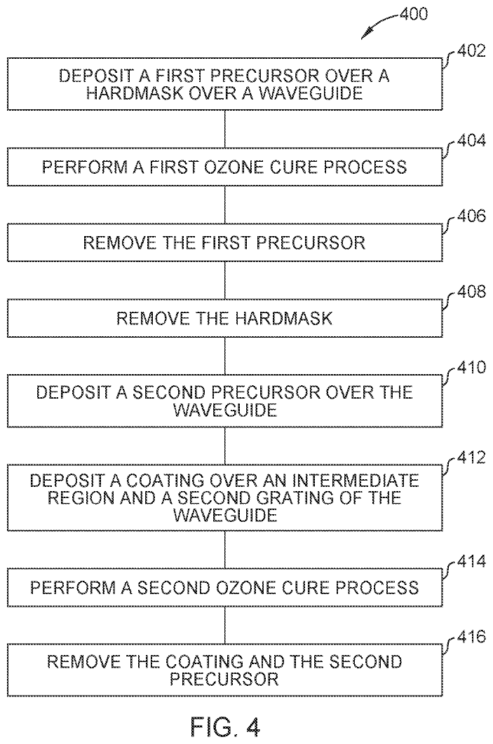

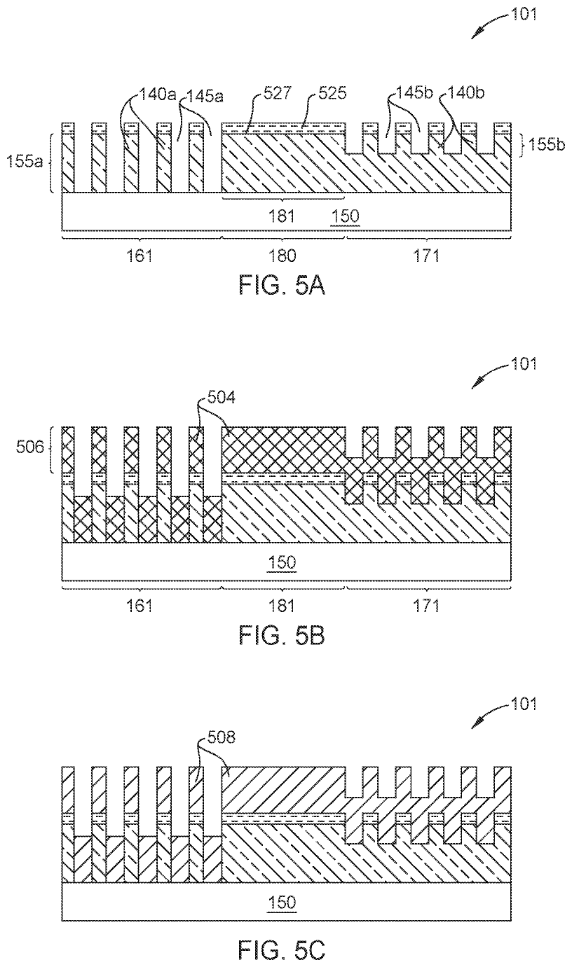

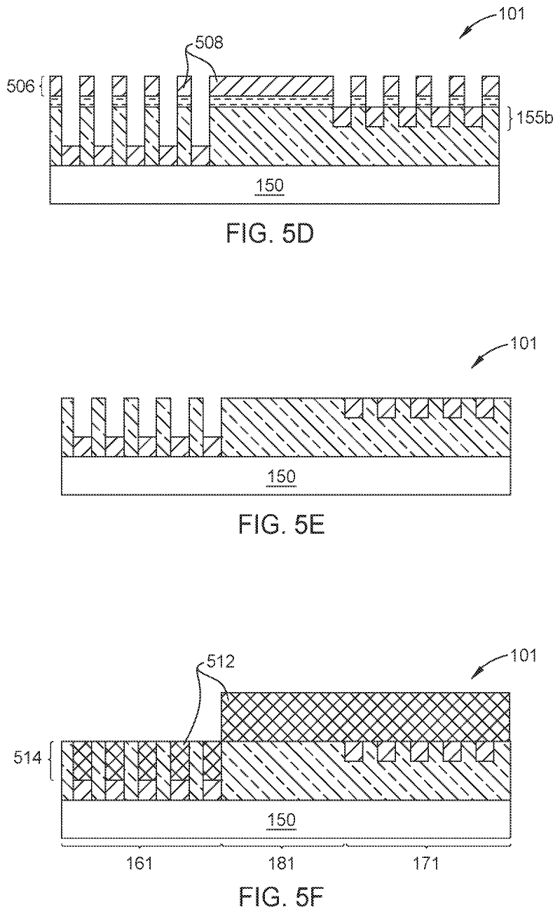

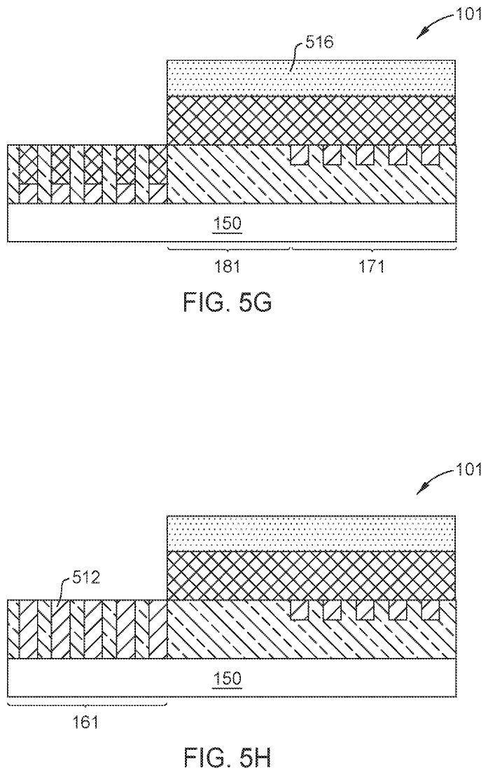

FIG. 4 is a flow diagram of a method 400 of forming a waveguide 100 according to one or more embodiments. FIGS. 5A-5H are schematic, cross-sectional views of a portion 101 of a waveguide 100 according to one or more embodiments.

FIG. 5A includes a plurality of first grating structures 140a disposed over a first grating 161 of the portion 101 of a waveguide substrate 150. Adjacent first grating structures 140a form a plurality of first trenches 145a therebetween. FIG. 5A further includes a plurality of second grating structures 140b disposed over a second grating 171 of the portion 101 of the waveguide substrate 150. Adjacent second grating structures 140b form a plurality of second trenches 145b therebetween. A third section 180 of the portion 101 of the waveguide 100 includes an intermediate region 181 which does not include grating structures 140 thereon or thereover. A hardmask 525 is disposed over an upper surface 527 of each of the first grating 161, the second grating 171, and the intermediate region 181. In one embodiment, which can be combined with other embodiments described herein, the hardmask may be a metal. In one embodiment, which can be combined with other embodiments described herein, the hardmask 525 includes chromium (Cr), titanium nitride (TiN), silicon carbide (SiC), silicon oxide (SiOₓ), zirconium oxide (ZrOₓ), titanium oxide (TiOₓ), tantalum nitride (TaN), aluminum nitride (AlN), carbon, or combinations thereof. In one embodiment, which can be combined with other embodiments described herein, the first grating 161 and the second grating 171 may correspond to any of the in-coupler grating 110, the pupil-expander grating 120, or the out-coupler grating 130, as shown in FIG. 1A.

The plurality of first grating structures 140a have a first depth 155a. The plurality of second grating structures 140b have a second depth 155b. In one embodiment, which can be combined with other embodiments described herein, the first depth 155a is greater than the second depth 155b.

At operation 402, as shown in FIG. 5B, a first precursor 504 is deposited over the waveguide 100. The first precursor 504 is deposited over the first grating 161, the second grating 171, and the intermediate region 181. The first precursor 504 has a first thickness 506.

At operation 404, as shown in FIG. 5C, a first ozone cure process is performed. The first ozone cure process cures the first precursor 504, leaving a cured first precursor 508.

At operation 406, as shown in FIG. 5D, the cured first precursor 508 is removed over the upper surface 527 such that the remaining first thickness 506 of the cured first precursor 508 is approximately equal to the depth 155b of the second trenches 145b. In one embodiment, which can be combined with other embodiments described herein, the cured first precursor is removed via an etch process.

At operation 408, as shown in FIG. 5E, the hardmask 525 is removed. In one embodiment, which can be combined with other embodiments described herein, the hardmask is removed via a chromium removal process.

At operation 410, as shown in FIG. 5F, a second precursor 512 is deposited over the waveguide 100. The second precursor 512 is deposited over the first grating 161, the second grating 171, and the intermediate region 181. The second precursor 512 has a second thickness 514. In one embodiment, which can be combined with other embodiments described herein, the first thickness 506 and the second thickness 514 are different. In one embodiment, which can be combined with other embodiments described herein, the first precursor 304 and the second precursor 312 may be the same material.

At operation 412, as shown in FIG. 5G, a coating 516 is deposited over the intermediate region 181 and the second grating 171. In one embodiment, which can be combined with other embodiments described herein, the coating 516 is deposited via inkjet deposition.

At operation 414, as shown in FIG. 5H, a second ozone cure process is performed. The second ozone cure process cures the second precursor 512 over the first grating 161, leaving a cured second precursor 518.

At operation 416, the coating 516 and the second precursor 512 located over the second grating 171 and the intermediate region 181 are removed.

In one embodiment, which can be combined with other embodiments described herein, any of the ozone cure processes are replaced with another external stimuli process in order to cure the first precursor 304/504 and/or the second precursor 312/512. External stimuli processes may include light (UV and/or visible), electron-beam, chemical (acid, base, thiol, water, and/or silanes), contact heat transfer, and/or vacuum.

In one embodiment, which can be combined with other embodiments described herein, the coating 316/516 is deposited via physical vapor deposition (PVD), chemical vapor deposition (CVD), atomic layer deposition (ALD), spincoat deposition, spray coating, electroplating, screenprint deposition, and/or dipcoating. In one embodiment, which can be combined with other embodiments described herein, the coating 316/516 includes screenprint, evaporation printing, microcontact printing, imprinting, nanoimprinting, embossing, aerosol spray, and/or aerosol jet.

While the foregoing is directed to embodiments of the present disclosure, other and further embodiments of the disclosure may be devised without departing from the basic scope thereof, and the scope thereof is determined by the claims that follow.

1. A method, comprising:
depositing a first precursor over a waveguide, the first precursor deposited over a first grating, a second grating, and an intermediate region between the first grating and the second grating of the waveguide, the first precursor deposited to have a first thickness;
performing a first cure process, the first ozone cure process curing the first precursor;
depositing a second precursor over the waveguide, the second precursor deposited over the first grating, the second grating, and the intermediate region, the second precursor deposited to have a second thickness;
depositing a coating over the intermediate region and the second grating;
performing a second cure process, the second ozone cure process curing the second precursor over the first grating; and
removing the coating and the second precursor over the second grating and the intermediate region.

2. The method of claim 1, wherein the first grating has a first depth, the second grating has a second depth, and the first depth is greater than the second depth.

3. The method of claim 1, wherein the first thickness and the second thickness are different.

4. The method of claim 2, wherein the second depth is equal to the first thickness, and the first depth is equal to the first thickness and the second thickness.

5. The method of claim 1, wherein the first precursor and the second precursor are the same material.

6. The method of claim 1, wherein the coating is deposited via inkjet deposition.

7. A method, comprising:
depositing a first precursor over a waveguide, the first precursor deposited over a first grating, a second grating, and an intermediate region between the first grating and the second grating of the waveguide, the first precursor deposited to have a first thickness, an upper surface of the first grating, the second grating, and the intermediate region having a hardmask material disposed thereon;
performing a first cure process, the first cure process curing the first precursor;
removing the first precursor over the upper surface;
removing the hardmask material;
depositing a second precursor over the waveguide, the second precursor deposited over the first grating, the second grating, and the intermediate region, the second precursor deposited to have a second thickness;
depositing a coating over the intermediate region and the second grating;
performing a second cure process, the second cure process curing the second precursor over the first grating; and
removing the coating and the second precursor over the second grating and the intermediate region.

8. The method of claim 7, wherein the first grating has a first depth, the second grating has a second depth, and the first depth is greater than the second depth.

9. The method of claim 8, wherein the removing the first precursor comprises etching the first precursor such that the first thickness and the second depth are equal.

10. The method of claim 7, wherein the first precursor and the second precursor are the same material.

11. The method of claim 7, wherein the coating is deposited via inkjet deposition.

12. The method of claim 7, wherein the hardmask material includes chromium (Cr), titanium nitride (TiN), silicon carbide (SIC), silicon oxide (SiOₓ), zirconium oxide (ZrOₓ), titanium oxide (TiOₓ), tantalum nitride (TaN), aluminum nitride (AlN), carbon, or combinations thereof.

13. A waveguide, comprising:
a first grating, a second grating, and an intermediate region between the first grating and the second grating of the waveguide;
the first grating comprising a first plurality of trenches at a first depth;
the second grating comprising a second plurality of trenches at a second depth;
a cured first fill material deposited over the first grating, the second grating, and the intermediate region;
a second fill material deposited over the first grating.

14. The waveguide of claim 13, wherein the second fill material is the same as the first fill material.

15. The waveguide of claim 13, wherein the second depth is larger than the first depth.

16. The waveguide of claim 13, wherein the first plurality of trenches are filled to the first depth with the first fill material, and the second plurality of trenches are filled to the second depth with the first fill material and second fill material.

17. The waveguide of claim 13, wherein the first fill material and the second fill material are the same material.

18. The waveguide of claim 13, wherein the first depth is larger than the second depth.

19. The waveguide of claim 13, wherein the intermediate region comprises a hardmask material disposed thereon

20. The waveguide of claim 19, wherein the hardmask material includes chromium (Cr), titanium nitride (TiN), silicon carbide (SiC), silicon oxide (SiOx), zirconium oxide (ZrOx), titanium oxide (TiOx), tantalum nitride (TaN), aluminum nitride (AlN), carbon, or combinations thereof.
